(19) United States
(12) Patent Application Publication
(10) Pub. No.: US 2004/0230808 A1
(43) Pub. Date: Nov. 18, 2004

(54) EDP system and a method for utilizing the EDP system

(75) Inventor: Stefan Schek, Neckargmuend (DE)

Correspondence Address: HOUSTON ELISEEVA, 4 MILITIA DRIVE, SUITE 4, LEXINGTON, MA, 02421, US

(73) Assignee: Leica Microsystems Heidelberg GmbH, Mannheim (DE)

(21) Appl. No.: 10/840,482

(22) Filed: May 6, 2004

(30) Foreign Application Priority Data
May 16, 2003 (DE) DE 103 22 295.2
Jul. 3, 2003 (DE) DE 103 30 244.1

(51) Int. Cl. H04K 1/00

(52) U.S. Cl. 713/182

(57) ABSTRACT

An EDP system having at least one EDP-assisted workstation (1, 2), in particular a PC (3, 4), computing system, process computer, network, etc., user-specific data that can encompass software adaptations or software settings, user interfaces, access authorizations, individually generated data, or the like being supplyable, is characterized in that the user-specific data are associated with a transportable, preferably miniaturized memory (5) that, for user-specific configuration of the workstation, communicates with the respective computer via a suitable interface (7, 8). A corresponding method serves for utilization of the system.

### RELATED APPLICATIONS

This application claims priority of the German patent applications 103 22 295.2 and 103 30 244.1 which are incorporated by reference herein.

### FIELD OF THE INVENTION

The invention concerns an EDP system having at least one EDP-assisted workstation, in particular a PC, computing system, process computer, network, etc., user-specific data that can encompass software adaptations or software settings, user interfaces, access authorizations, individually generated data, or the like being supplyable.

The invention further concerns a method for supplying user-specific data in the context of EDP-assisted workstations, e.g. in particular PCs, computing systems, process computers, networks, etc., in which context the user-specific data ca encompass software adaptations or software settings, user interfaces, generated data, access authorizations, or the like, in particular utilizing the EDP system according to the present invention.

### BACKGROUND OF THE INVENTION

A fundamental desire exists to make individual computers, for example PCs and EDP systems, easy to manipulate. If a computer is being used by a single person, it is usual to set up that computer for the requirements of the particular application and with reference to the user, each user successively making individual settings. In this regard, each computer possesses user-specific data that, however, are very predominantly associated with the particular computer, the particular EDP system, or the workstation supported by the computer. If the intention is to make user-specific data accessible anywhere at any time, those data have hitherto been conveyed to a central data retention system in computer networks; the computer networks can be internal or external networks, for example the Internet.

A user often has occasion to work in different networks. For example, it is entirely conceivable for a company employee to work in the company network and to be active in the Internet at various workplaces. For example, he utilizes his home network in order to prepare proposals, and would like to find his personal, user-specific data in all the networks. A user thus expresses the desire to encounter, regardless of workplace and of the particular active network, a uniform user interface that he has set up over time and understands how to work with.

The different networks are, however, (not least for security reasons), usually separated or clearly delimited from one another. User-specific data retention in only one network is therefore not sufficient; as a result, centralized user management and user data management is extremely difficult given all the networks and platforms on which the user is active.

There is also the fact that user-specific workstations often are not connected to networks, so that they are essentially individual workplaces. Centralized user data management is therefore ruled out a priori. As an example of a very particular user-specific workstation, the reader may be referred to DE 39 33 064 C2, which describes the workstation of an EDP-assisted microscope.

### SUMMARY OF THE INVENTION

It is therefore the object of the present invention to configure and develop an EDP system, which in the simplest case can encompass an individual computer or PC, in such a way that user-specific adaptation on the basis of user-specific data is easily possible without integrating the individual computer into a network and without interconnecting mutually independent networks. The need for a complex central data retention system is to be eliminated. A corresponding method for supplying user-specific data is to be described.

With reference to the EDP system according to the present invention, the aforesaid object is achieved by an EDP system comprising:

at least one EDP-assisted workstation,

user-specific data provided on said workstation, wherein the user-specific data encompass software adaptations, software settings; user interfaces, access authorizations, individually generated data, or the like;

a transportable miniaturized memory, wherein the miniaturized memory holds a user-specific configuration of the workstation; and

a suitable interface, through which the transportable miniaturized memory communicates with the workstation.

What has been recognized according to the present invention is that for user-specific adaptation of a computer, a computing system, a process computer, a network, etc., it is not necessary to interconnect the participating computers and network by means of central data retention in a quasi-higher-order computer network. Instead, the previous procedure is departed from in that the user-specific data are associated with a transportable, preferably miniaturized memory. By way of the memory and the data present therein, a user-specific configuration of the respective computer or workstation takes place, specifically by the fact that the memory communicates via a suitable interface with the respective computer, and performs an adaptation of the data and a user-specific configuration of the workstation.

For example, it is possible to design the interface for communication between the portable memory and the respective computer for wireless data transfer. The use of an infrared interface, a LAN interface, or a Bluetooth interface is possible. The wireless data transfer could be designed in such a way that as soon as the memory or the user having the memory approaches the computer or workstation, a message relevant thereto takes place in the computer or network. After input of an identification, a user-specific interface could then already be activated in consideration of certain access rights. User-specific data would then always be available, or indeed already activated and optionally implemented, when the respective memory is located within an action radius (to be defined) of the respective computer.

A conventional contact-based interface of the computer could also serve as the interface, a parallel or serial interface of the computer being usable in traditional fashion. In particularly advantageous fashion, a USB port of the computer is possible as the interface. Once again in further advantageous fashion, a commercially available USB flash memory in stick form, referred to as a USB Disk on Key, which can be carried on a keyring, could be used as the transportable and miniaturized memory. Particularly advantageous in this context would be a USB Stick that is equipped with an additional security chip having write-protected memory regions and unequivocal, permanently allocated identity features. In any case, a memory of this kind can easily be inserted into the USB port of a workstation, thereby allowing the user-specific data to be transferred from the memory stick to the workstation. Advantageously, the transportable memory would be a plug-and-play-capable data memory.

It is conceivable in principle to provide a special docking station for the transportable memory, which is always to be operated before the computer or workstation is used. The data memory, in whatever form, could be conveyed to this docking station, whereupon a data exchange and the adaptation take place on the basis of the user-specific data.

The transportable memory can encompass a wide variety of data, for example user-specific software profiles. It is advantageous in particular if the memory encompasses license-dependent access authorizations or additional authorization profiles. In a deviation from the previous procedure, it is thus possible to configure licenses transportably, namely to issue user-specific licenses that are in fact associated with the user and not, as heretofore, more or less necessarily with a device. According to the present invention, licenses and thus access authorizations can be “transported,” so that the access-authorized person can make use of his access authorization on any workstation—inside or outside his company, domestically or abroad—at which he is located.

It is furthermore conceivable for the memory to encompass data that can be influenced or modified in the course of use as a function of the duration, nature, and qualification of the use. For example, licenses can be loaded onto the memory at a later time, licenses can be withdrawn, or access authorizations can be expanded as a function of the experience of the particular user. For example, expanded access authorizations could be granted, almost automatically, when the user has exceeded a certain practice level, definable work results, or other limits, however they are to be defined.

In any event, the use of the transportable memory in the context of the EDP system according to the present invention creates a high degree of flexibility and thus optimum user adaptation capabilities for the software. This in turn results in a very considerable efficiency improvement together with a decrease in workload, especially in terms of the complex utilization of demanding workstations. In very particularly advantageous fashion, for example, the EDP system according to the present invention can be used in EDP-assisted microscopy, preferably in scanning microscopy and in particular in confocal systems. With corresponding authorization, a user can use the system “released” to him by way of the data memory regardless of the system's location, since he carries with him the user data for adaptation that authorize him, and the memory communicates accordingly with the system.

The object cited initially is achieved in terms of a method for supplying user-specific data in the context of at least one EDP-assisted workstation; comprising the steps of:

providing user-specific data, which encompass software adaptations, software settings, user interfaces, generated data, access authorizations, or the like;

storing the user-specific data on a transportable, miniaturized memory, and

communicating of the miniaturized memory with the workstation via a suitable interface.

It should be mentioned once again very specifically that, in very particularly advantageous fashion, the memory medium is an easily handled memory medium, for example a commercially available USB Disk on Key, i.e. a USB flash memory stick that can be carried like a key fob on a keyring. To use a computer or log onto a workstation, the USB flash memory is inserted into what is today a usual USB port of the respective workstation or computer, whereupon communication begins between the memory and the computer. Assuming a plug-and-play-capable data memory, a data exchange automatically takes place and, for example, the user interface is immediately set up in user-specific fashion, in consideration of the particular access authorization.

According to the present invention, management of software profiles is possible. This offers the advantage that the user can implement or activate his individual user interface on any workstation that accepts his individual data memory. For example, upon termination of the respective program, the state of the user interface (GUI state) could be persistently serialized and automatically re-established at the next start (by the same user). The user-specific data and program options could likewise be retained in consistent fashion.

Specifically with regard to particular workstations, for example in the context of the confocal system already mentioned several times, the user could have allocated to him by an administrator a user level (to be defined in whatever fashion) that corresponds to relevant particular user knowledge. The user level could be made dependent, for example, on successful participation in a training program, an instruction session, or the like. Different user levels could, for example, be allocated to beginners, to those with some experience, and to experts. Those levels are recorded on the memory stick and can be adapted or modified by a person or authority (to be defined). An automatic adaptation with increasing experience can also take place, specifically as a function of experience over time or even as a function of completion of an implemented training program. In any event, optimum adaptation of the user interface to the needs of the respective user can be effected, specifically in consideration of an authority that allocates the access authorization.

In confocal systems in particular, it is conceivable in additionally advantageous fashion to allocate selective access authorizations to portions of the confocal system by way of the memory. The user of a confocal system thus has allocated to him, by the administrator in charge, an access authorization profile that best corresponds to his user knowledge. This access authorization profile could be made up of several sub-system authorizations of a confocal system, for example an authorization to use the UV subsystem or a multi-photon (MP) subsystem, or the use of various service tools. All authorizations are recorded on the data memory and can be adapted administratively, for example following successful completion of a training program. It is in any case possible in general principle to make workstations accessible only to specific persons, so that abuse of the respective system by incompetent persons is largely ruled out.

As already mentioned previously, according to the present invention a transportable license for legitimately acquired software packages can be implemented. As a deviation from existing practices, a license is thus in fact personal and is not—for lack of transportability—immobilized on a specific system or computer.

If users purchase further licenses, for example a 3D evaluation package in the context of confocal microscopy, the user can thus use his license on different workstations because the license information is stored in the memory; as a result, the license is transportable and can be used anywhere.

Acquired data can also be stored and transported on the transportable memory, thereby further enhancing the flexibility of the system. For example, image data acquired from a confocal system can be stored on the memory stick and taken away, so that a separate data transfer is no longer necessary. Lastly, a scenario relevant to the invention will be presented in order to illustrate the invention.

In a research institute, a scientist works on several confocal microscope systems. The different systems existing thereon are not, or only partially, interconnected via a network. The scientist states that he wants to perform evaluations at home. The scientist furthermore visits research colleagues within the country and abroad at a wide range of institutions where corresponding systems are available to him. Assuming appropriately configured systems, he can work everywhere with the same software, but it usually exhibits a different user profile or different implementations. Either the scientist adapts to the particular conditions (which is always difficult), or he must set up the application software to meet his needs, always having to ensure that this is done so it is easily reversible in order not to interfere with other people's work. Utilizing the mobile memory at each workstation renders the formerly complex procedure superfluous. For example, by way of his user-specific data and access authorizations, he can always call up the software inventory and familiar user interface that correspond to his authorization. The acquired images can be stored and also transported by means of the memory, so that laborious saving of the data onto separate data memories is no longer necessary. The result is that the system according to the present invention makes work very considerably simpler, especially because a user-specific environment can be created anywhere.

### BRIEF DESCRIPTION OF THE DRAWINGS

There are various ways of advantageously embodying and developing the teaching of the present invention. The reader is referred, for that purpose, on the one hand to the claims subordinate to Claims 1 and 16, and on the other hand to the explanation below of two exemplary embodiments of the invention with reference to the drawings. In conjunction with the explanation of the preferred exemplary embodiments of the invention, an explanation is also given of generally preferred embodiments and developments of the teaching. In the drawings:

FIG. 1 shows, in a schematic sketch, a general exemplary embodiment of an EDP system according to the present invention; and

FIG. 2 schematically depicts a concrete exemplary embodiment of an EDP system according to the present invention with a microscopy workstation, preferably for scanning microscopy.

### DETAILED DESCRIPTION OF THE INVENTION

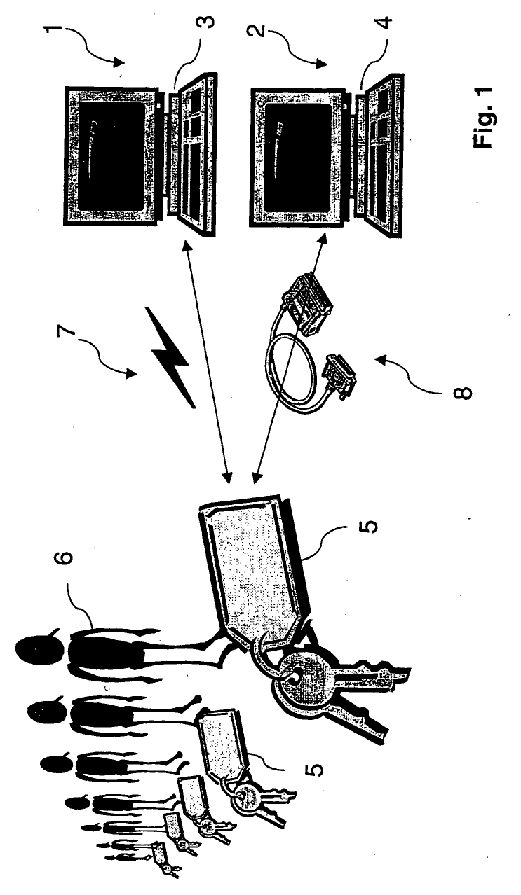

FIG. 1 shows the basic features of the EDP system according to the present invention, two EDP-assisted workstations 1, 2 being provided in the exemplary embodiment selected here. These workstations 1, 2 each encompass a PC 3, 4, likewise depicted schematically here.

User-specific data, with which a software adaptation or software setting can take place, are supplied.

According to the present invention, miniaturized memories 5 that contain the user-specific data are provided for that purpose. Concretely, these are USB flash memories. Memories 5 are associated with different users 6 or are carried by those users 6 as key fobs.

FIG. 1 further indicates that for user-specific configuration of the workstation, the miniaturized memory communicates with the respective PC 3, 4 via a suitable interface 7, 8, interface 7 being an interface for wireless data transfer and interface 8 being a conventional contact-based interface.

In light of the statements made above, it is clear that the EDP system according to the present invention makes possible personalized use, since each user possesses his own memory or memory stick that refers unequivocally to him. Each of these memories carries an unequivocal identifier that ultimately corresponds to a user's personal fingerprint. It is thus possible to apply the digital fingerprint to data acquired with a confocal workstation in order to establish the provenance of that data (with respect to the user). This is of particular interest especially when it comes to publication of research results, specifically so that even after the fact, an unequivocal allocation of results can be made and verified.

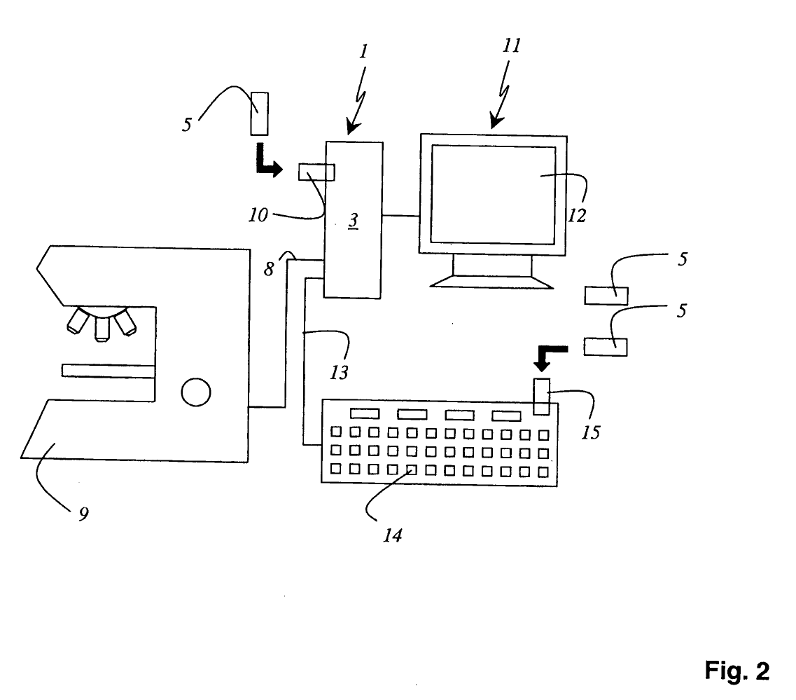

FIG. 2 shows an EDP system according to the present invention in which workstation 1 is effectively connected via a contact-based interface 8 to a microscope 9. Concretely, what is involved here is a confocal scanning microscope. A further interface 10 serves for docking of a miniaturized memory 5; this interface 10 can be embodied in contact-based or wireless fashion.

Also connected to workstation 1 is a monitor 11 that encompasses a user interface 12.

A keyboard 14 is connected to workstation 1, and to PC 3 provided therein, via a further interface 13. Keyboard 14, as well, can be equipped with an interface 15 for docking or inserting miniaturized memories 5. The exemplary embodiment discussed above makes clear in any case the extent to which the EDP system according to the present invention can be a very particular EDP-protected workstation, namely a microscope workstation.

In order to avoid repetition, the reader is otherwise referred to the general portion of the description.

Lastly, it should be remarked that the above statements, in particular with reference to applications of the EDP system according to the present invention, serve for discussion of the teaching claimed but do not limit that teaching to the above statements.

What is claimed is:

1. An EDP system comprising:
at least one EDP-assisted workstation,
user-specific data provided on said workstation, wherein the user-specific data encompass software adaptations, software settings; user interfaces, access authorizations, individually generated data, or the like;
a transportable miniaturized memory, wherein the miniaturized memory holds a user-specific configuration of the workstation; and
a suitable interface, through which the transportable miniaturized memory communicates with the workstation.

2. The system as defined in claim 1, wherein the workstation is a PC, a computing system, a process computer or a network.

3. The system as defined in claim 1, wherein the interface is designed for wireless transfer of the data.

4. The system as defined in claim 3, wherein the interface is designed as an infrared interface.

5. The system as defined in claim 3, wherein the interface is designed as a LAN interface.

6. The system as defined in claim 3, wherein the interface is designed as a Bluetooth interface.

7. The system as defined in claim 1, wherein a conventional contact-based interface of the workstation serves as the interface.

8. The system as defined in claim 7, wherein a parallel or serial interface of the workstation serves as the interface.

9. The system as defined in claim 7, wherein a USB port of the workstation serves as the interface.

10. The system as defined in claim 9, wherein the transportable memory is embodied as a USB flash memory.

11. The system as defined in claim 1, wherein a docking station for he transportable memory is associated with the interface.

12. The system as defined in claim 1, wherein the transportable memory is embodied as a plug-and-play-capable data memory.

13. The system as defined in claim 1, wherein the transportable memory encompasses user-specific software profiles.

14. The system as defined in claim 1, wherein the transportable memory encompasses license-dependent access authorizations or access authorization profiles.

15. The system as defined in claim 1, wherein the transportable memory encompasses data that can be influenced or modified in the course of use as a function of the duration, nature, and qualification of the use.

16. The system as defined in claim 1, wherein the workstation is an EDP-assisted microscopy workstation, preferably for scanning microscopy.

17. A method for supplying user-specific data in the context of at least one EDP-assisted workstation; comprising the steps of:
providing user-specific data, which encompass software adaptations, software settings, user interfaces, generated data, access authorizations, or the like;
storing the user-specific data on a transportable, miniaturized memory, and
communicating of the miniaturized memory with the workstation via a suitable interface.

18. The method as defined in claim 17, wherein the workstation is configured as a PC, a computing system, a process computer or a network.

19. The method as defined in claim 17, wherein the user-specific data are transferred wirelessly.

20. The method as defined in claim 17, wherein the user-specific data are transferred via a conventional interface of the workstation.

21. The method as defined in claim 17, wherein the workstation is a scanning workstation, preferably confocal system.
